(19) United States
(12) Patent Application Publication
(10) Pub. No.: US 2017/0362354 A1
(43) Pub. Date: Dec. 21, 2017

(54) FUNCTIONAL OR TELECHELIC POLYOLEFIN, DERIVATIVES THEREOF, AND PROCESS FOR PREPARING SAME

(71) Applicants: Universite Claude Bernard Lyon I, Villeurbanne Cédex (FR); Centre National de la Recherche Scientifique, Paris Cedex 16 (FR); CPE Lyon Formation Continue ET Recherche, Villeurbanne Cédex (FR)

(72) Inventors: Sébastien Norsic, Lyon (FR); Franck D'Agosto, Genas (FR); Christophe Boisson, Tramoyes (FR)

(73) Assignees: Universite Claude Bernard Lyon I, Villeurbanne Cédex (FR); Centre National de la Recherche Scientifique, Paris Cedex 16 (FR); CPE Lyon Formation Continue ET Recherche, Villeurbanne Cédex (FR)

(21) Appl. No.: 15/534,668

(22) PCT Filed: Dec. 11, 2015
(86) PCT No.: PCT/FR2015/053440

§ 371 Date: Jun. 9, 2017

(30) Foreign Application Priority Data
Dec. 12, 2014 (FR) 1462326

(51) Int. Cl. C08F 10/02; C08F 2/40; C08F 4/52

(52) U.S. Cl. CPC C08F 10/02; C08F 4/52; C08F 2/40; C08F 2500/02

(57) ABSTRACT

The invention herein pertains to a telechelic polyolefin of formula (III) or (IV) and to a process for its preparation,

Z-A-(CH₂)ₚ—B′ (III)

Z-A-(CH₂)ₚ—B (IV)
A being a polymer chain obtained by homopolymerization of ethylene or by copolymerization of ethylene and an alpha-monoolefin;
B′ being selected from the group consisting of N(SiMe₃)₂; N(SiMe₂CH₂CH₂SiMe₂); para-C₆H₄(NMe₂); para-C₆H₄(OMe); C₆H₄(N(SiMe₃)₂); ortho-CH₂—C₆H₄NMe₂; ortho-CH₂—C₆H₄OMe; C₆F₅; C₃F₇; C₆F₁₃; CH(OCH₂CH₂O);
B being the function B′ or a function derived from B′;
p being an integer from 0 to 50, advantageously from 0 to 11;
   Z being a function selected from the group consisting of halogens; thiols; thiol derivatives; azides; amines; alcohols; carboxylic acid function; isocyanates; silanes; phosphorus derivatives; dithioesters; dithiocarbamates; dithiocarbonates; trithiocarbonates; alkoxyamines; vinyl function; dienes; and the group -A-(CH₂)ₚ—B′.

### DOMAIN OF THE INVENTION

The invention herein concerns a process for synthesizing functional telechelic polyolefins, as well as functional telechelic polyolefins of which one end (or both ends) of the principal polymer chain has/have been functionalized.

These polyolefins can be used as a matrix/base structure in organic, inorganic, hybrid or composite materials.

### PRIOR ART

In general, a polymer capable of generating a new polymerization or a new reaction is referred to as a “functional polymer”, due to the reactivity of one of its chain ends, or a “telechelic polymer”, due to the reactivity of each of its chain ends. In this type of molecule, the reactive groups located at the chain ends do not originate from monomers.

Several methodologies for the synthesis of ethylene-based functional polyolefins have been described in prior art.

One method consists in polymerizing ethylene (and/or a mono-alpha-olefin) in the presence of a dual-component catalyst system based on a transfer agent. Such a method notably makes it possible to obtain a vinyl-terminated polyolefin (Boisson, D'Agosto et al., Angew Chem Int Ed Engl. 2013, 52, 3438-3441). This vinyl termination can be chemically modified by additional steps (T. Chenal and M. Visseaux, “End-capped Oligomers of Ethylene, Olefins and Dienes, by means of Coordinative Chain Transfer Polymerization using Rare Earth Catalysts”, INTECH, 2014, 4—Oligomerization of Chemical and Biological Compounds, chapter 1, pages 3-30).

A second method consists in modifying the polyolefin chemically, in bulk or in solution. These are generally radical-type reactions which allow the introduction of functionality along the main chain of the polymer.

However, this method has at least the following two disadvantages:
the formation of ramous or branched architectures that can alter the properties of the polyolefin;
the random introduction of functional groups, in an uncontrolled manner, at the end of the main chain of the polymer.

A third method consists in:
polymerizing a diene monomer in a controlled manner, using an anionic process;
functionalizing the polymer by a functional terminating agent;
hydrogenating the polymer so as to obtain a functional polyolefin.

This third method has the disadvantage of requiring a succession of steps and the use of different types of solvents, which can make it complex and costly.

Several ways of synthesizing telechelic polymers have been described in prior art. However, as regards the synthesis of telechelic polyolefins, three principal methods have been developed:

(i) The first involves the synthesis of a hydroxy-telechelic polybutadiene via an anionic process. The butadiene is first polymerized before a phase of hydrogenation of the unsaturations in the polymer chain. The thus-obtained telechelic polyethylene has identical chain ends; it is also branched due to the presence of the ethyl groups resulting from the 1.2 units of the butadiene. This type of polymer is commercially available under the name Kraton L2203.

(ii) Another synthesis process involves polymerization by metathesis, by opening the cycle of the cyclooctadiene. The polymer obtained is then hydrogenated to give a hydroxy-telechelic polyolefin (Hillmyer et al., Macromolecules 1995, 28, 7256-7261).

(iii) Finally, the live polymerization of ethylene has also been employed in the presence of a palladium-based complex. This complex not only initiates the live polymerization reaction of ethylene, but also functionalizes the chain ends. The telechelic branched polyethylene obtained has, at the chain ends, either identical ester functions, or an ester function and a ketone function (Brookhart, Macromolecules 2003, 36, 3085). In the same vein, document US 2007/0010639 describes the three-step synthesis of telechelic polypropylene having polar chain ends. Olefin monomers having protected functionalities are used at the beginning of polymerization, to create a short segment carrying these functions laterally. The (co-)polymerization of propylene is then carried out. Afterwards, a functional monomer is used again to form a second short terminal segment carrying functions laterally.

The term “live polymerization” is deemed to mean a chain polymerization that does not comprise chain transfer or termination reactions. The live polymerization of olefins makes it possible to prepare functional polymers at one or both ends of the chain. However, in the field of olefins polymerization, live polymerization is limited by the fact that only one chain per transition metal is produced, which poses a problem in terms of production cost. Polymerization by coordination catalysis has the advantage of producing a large number of chains per transition metal. Therefore, there is a need for a system allowing the preparation of telechelic polyolefins—notably polyethylene—under coordinating catalysis polymerization conditions that are satisfactory in terms of production cost.

Document WO2013/135314 describes a telechelic polyolefin in which at least one end of the polymer chain is necessarily a vinyl group that can possibly be functionalized. This polyolefin is obtained by polymerization of ethylene in the presence of a transfer agent including a vinyl function. The process described in prior art relates more particularly to a polyolefin obtained by polymerization of at least 95 mol % of ethylene in the presence of a di(alkenyl) magnesium transfer agent containing preferably 6 to 9 CH₂ groups between the magnesium and the vinyl function.

The compounds of prior art designated as functional transfer agents have certain limitations.

For example, document WO 2013/135314 describes functional transfer agents of the Mg((CH₂)₉—CH═CH₂)₂ type, which can be used to prepare telechelic polyolefins. They have the disadvantage of providing a CH═CH₂ vinyl functionality at one chain end—a function devoid of heteroatoms, which can constitute a limitation in certain applications.

Document US 2013/0274407 describes functional transfer agents corresponding to the formula (AT) below. These compounds make it possible to insert aromatic groups bearing heteroatoms an the end of the polybutadiene chain. However, the presence of an aromatic ring can be a limitation, depending on the application envisaged.

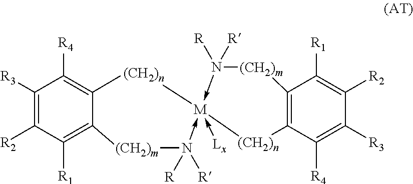

The problem that the invention herein proposes to solve notably concerns the synthesis of a polyolefin in which one or both ends of the main chain is/are functionalized and modifiable. This polyolefin may in particular be a homopolyethylene or a copolymer obtained by copolymerizing ethylene with a α-mono-olefin.

### EXPLANATION OF THE INVENTION

The Applicant has developed a process for the preparation of a polyolefin of which at least one—advantageously both—chain end has a functional group. In other words, it involves the preparation of a polyolefin of which at least one of the ends can easily react to facilitate the incorporation of the said polyolefin into, for instance, a hydrophilic or hydrophobic environment, in organic, inorganic, hybrid and composite materials.

This polyolefin is advantageously telechelic (functionalization of both ends) and linear. It advantageously has two separate chain ends that can react selectively due to their difference in reactivity.

The Applicant has developed a process for the synthesis of a polyolefin that carries at least one end-chain function, and of telechelic polyolefins of at least one function is derived from the compound designated as a functional transfer agent, corresponding to formula (II).

More precisely, the invention herein pertains to a process for preparing a polyolefin having at least one functionalized chain end, in accordance with the following step (a): (a) preparation a compound of formula (I) by homopolymerization of ethylene or by copolymerization of ethylene and an alpha-mono-olefin in the presence of a transfer agent of formula (II):

Y-(A-(CH₂)ₚ—B′)ₘ (I)

Y((CH₂)ₚB′)ₘ (II)

in which:
when m=2, Y is an alkaline earth metal or zinc and, when m=3, Y is aluminum;
A is a polymer chain obtained by homopolymerization of ethylene or by copolymerization of ethylene and an alpha-mono-olefin;
B′ is selected from the group consisting of N(SiMe₃)₂; N(SiMe₂CH₂CH₂SiMe₂); para-C₆H₄(NMe₂); para-C₆H₄(OMe); C₆H₄(N(SiMe₃)₂); ortho-CH₂—C₆H₄NMe₂; ortho-CH₂—C₆H₄OMe; C₆F₅; C₃F₇; C₆F₁₃; and CH(OCH₂CH₂O);
p is an integer from 0 to 50, advantageously from 0 to 11.

In the present application, the term “alpha-mono-olefin” means one or more alpha-mono-olefins—preferably one single alpha-monoolefin.

According to one advantageous implementation, B′ is chosen from the group including N(SiMe₃)₂; N(SiMe₂CH₂CH₂SiMe₂); para-C₆H₄(NMe₂); para-C₆H₄(OMe); C₆H₄(N(SiMe₃)₂); C₆F₅; C₃F₇; C₆F₁₃; CH(OCH₂CH₂O).

Advantageously, B′ is not one of the ortho-CH₂—C₆H₄NMe₂ and ortho-CH₂—C₆H₄OMe groups, notably when p=0.

The above-mentioned compounds N(SiMe₃)₂; N(SiMe₂CH₂CH₂SiMe₂); C₆F₅; C₃F₇; C₆F₁₃; para-C₆H₄—NMe₂; para-C₆H₄—O-Me; para-C₆H₄—N(SiMe₃)₂; ortho-CH₂—C₆H₄NMe₂; ortho-CH₂—C₆H₄OMe and CH(OCH₂CH₂O) respectively correspond to the following compounds (* denotes a hydrogen-free carbon atom and ** one CH group):

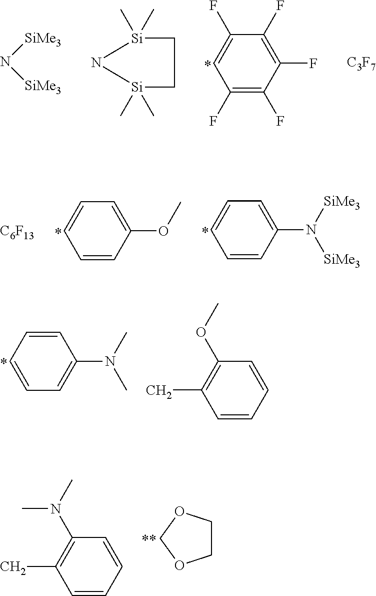

In general, the group B′ from the transfer agent is not a vinyl group.

Advantageously, the polymer chain A is a linear polyethylene or a copolymer obtained by copolymerizing ethylene and an alpha-mono-olefin (a single carbon dual bond=polymerizable carbon). The term “alpha-mono-olefin” also includes styrene and any other vinyl-aromatic type monomer.

The alpha-mono-olefin used in the invention is advantageously chosen from the group comprising olefins of formula CH₂═CH—CₓH₂ₓ₊₁ (x=1 to 6), styrene and derivatives of styrene.

Advantageously, the polymer chain A is a polymer of:
70 to 100 mol % of ethylene monomer, more preferably 95 to 99.9 mol %;
0 to 30 mol % of an alpha-mono-olefin selected from the group consisting of alpha-mono-olefins, styrene and any other vinyl-aromatic monomer, more advantageously 0.1 to 5 mol %; advantageously when the alpha-mono-olefin is selected from the group consisting of olefins of the formula CH₂═CH—CₓH₂ₓ₊₁ (x=1 to 6), styrene and styrene derivatives.

According to one preferred implementation, the polymer chain A is a linear polyethylene, namely a homopolymer of ethylene of formula —(CH₂—CH₂)ₙ—, where n is an integer advantageously from 7 to 3600, and even more advantageously from 17 to 360.

The polymer chain A advantageously has a number-average molar mass between 200 g/mol and 100,000 g/mol, more advantageously between 500 g/mol and 50,000 g/mol, yet more advantageously between 500 g/mol and 20,000 g/mol, and even more advantageously between 500 g/mol and 10,000 g/mol.

The number-average molar mass can notably be obtained by steric exclusion chromatography, in accordance with the general knowledge of an appropriately-qualified professional. For instance, an appropriately-qualified professional can refer to the protocol described in document WO 2010/139450.

The use of the transfer agent of formula (II) in a process for preparing a polyolefin of formula (I), (III) or (IV) also forms part of the present invention:

Z-A-(CH₂)ₚ—B′ (III)

Z-A-(CH₂)ₚ—B (IV)

As already indicated, the transfer agent of formula (II) Y((CH₂)ₚ—B′)ₘ is advantageously defined by:
m=2 or 3;
Y is an alkaline earth metal or zinc when m=2;
Y is aluminum when m=3;
B′ is selected from the group consisting of N(SiMe₃)₂; N(SiMe₂CH₂CH₂SiMe₂); C₆F₅; C₃F₇; C₆F₁₃; para-C₆H₄—NMe₂; para-C₆H₄—O-Me; para-C₆H₄—N(SiMe₃)₂; and CH(OCH₂CH₂O);
p is an integer from 0 to 50, advantageously from 0 to 11.

According to one particular implementation, the integer p is at least equal to 1. It can therefore be from 1 to 50 or from 1 to 11.

The polyolefins of formulas (I), (III) and (IV) are advantageously linear. The polyolefins of formula (III) and (IV) advantageously have two separate chain ends that can react selectively because of their difference in reactivity.

By way of example, the process for synthesizing the transfer agent of formula (II) advantageously comprises the reaction of the metal (especially when m=2 and Y=Mg) with a compound of formula X—(CH₂)ₚ—B′, X being a halogen, preferably a bromine atom; B′ being selected from the group consisting of N(SiMe₃)₂; N(SiMe₂CH₂CH₂SiMe₂); C₆F₅; C₃F₇; C₆F₁₃; para-C₆H₄—NMe₂; para-C₆H₄—O-Me; para-C₆H₄—N(SiMe₃)₂; and CH(OCH₂CH₂O); and p being an integer from 0 to 50.

On the other hand, when Y=Al, the transfer agent is advantageously prepared from AlCl₃.

According to one preferred implementation, the group B′ of the transfer agent of formula (II) is advantageously N(SiMe₂CH₂CH₂SiMe₂) or N(SiMe₃)₂.

The transfer agent is preferably a magnesium compound.

According to one particular implementation, it is Mg[(CH₂)ₚ—N(SiMe₂CH₂CH₂SiMe₂)]₂ or Mg[(CH₂)ₚ—N(SiMe₃)₂]₂, where p=1 to 11 and, preferably, p=3.

The polyolefin of formula (I) is advantageously obtained in a multi-component catalytic system which consists of transfer agent of formula (II) and a catalyst. This catalyst is a compound making it possible to generate an active species to catalyze the formation of the polymer chain A. It can notably be a catalyst based on a transition metal or a lanthanide—advantageously a metallocene comprising the basic structure (Cp¹)(Cp²)M ou E(Cp¹)(Cp²)M.

This catalyst makes it possible to implement the catalytic polymerization of the olefin (ethylene and, where appropriate, alpha-mono-olefin) by coordination/insertion, a large number of polymer chains being produced per catalyst molecule.

Generally, M is a group 3 or 4 metal or a lanthanide.

Furthermore, Cp¹ is advantageously a cyclopentadienyl, fluorenyl or indenyl group, with this group being substituted or otherwise.

Cp² is advantageously a cyclopentadienyl, fluorenyl or indenyl group, with this group being substituted or otherwise.

The group E is a group bridging the ligands Cp¹ and Cp². The metallocenes in which the two groups Cp¹ and Cp² are bridged are commonly called ansa-metallocenes. The group E can in particular be of formula M′R¹R² in which M′ is an element of group 14 or a chain of elements of group 14; R¹ and R² being identical or different and selected from the group including the alkyl or aryl groups incorporating from 1 to 20 carbon atoms. The group E may be, for example, —C(CH₃)₂—, —CH₂—CH₂—, or —Si(CH₃)₂—.

The compound based on a transition metal or lanthanide can also have a non-metallocene structure such as those defined in the review by V. C. Gibson and S. K. Spitzmesser (Chem. Rev. 2003, 103, 283-315).

Where appropriate, especially when the metal of the compound is not a lanthanide or a Group 3 metal, a co-catalyst may be used in combination with the catalyst described above. An appropriately-qualified professional will be able to choose the appropriate co-catalyst.

According to a particularly-preferred implementation, the catalyst can be obtained from the metallocene compound of formula (C₅Me₅)₂ MX₂Li(OEt₂)₂, M being a metal of group 3 or a lanthanide, and X preferably being a halogen. It can advantageously be a lanthanide compound—preferably Nd—and notably (C₅Me₅)₂ NdCl₂Li(OEt₂)₂.

The catalyst can also be obtained from a lanthanide metallocene compound such as, for example, the compounds {(Me₂Si(C₁₃H₈)₂)Nd(μ-BH₄) [(μ-BH₄)Li(THF)]}₂, Me₂Si(C₁₃H₈)₂)Nd(BH₄)(THF), (Me₂Si(2,7-tBu₂-C₁₃H₆)₂)Nd(BH₄)(μ-BH₄)Li(éther)₃, Me₂Si(3-Me₃Si—C₅H₃)₂NdBH₄(THF)₂; {Me₂Si(3-Me₃Si—C₅H₃)₂NdCl}; {Me₂Si(C₅H₄)(C₁₃H₈)NdCl}; and [Me₂Si(C₅H₄)(C₁₃H₈)Nd(BH₄)₂][Li(THF)].

The catalyst can notably be obtained from a metallocene borohydride compound of a lanthanide, as described in document WO 2007/054224.

The invention herein also pertains to the derivatives of the monofunctional polyolefin of formula (I), namely any polyolefin resulting from the termination, for example by hydrolysis, of at least one of the chain ends of the polyolefin of formula (I) and the modification of the B′ group in accordance with reactions known to an appropriately-skilled professional.

Thus, in the process for preparing the polyolefin having at least one functionalized chain end, step (a) is advantageously followed by a step (b) which consists in reacting the compound of formula (I) with a chain-end agent.

This terminator agent can advantageously be a functionalizing agent.

It allows the cleavage of the Y-A bonds of the polyolefin of formula (I).

According to one particular implementation, step (b) can be followed by a step (c) that is a modification reaction of the B′ function—preferably a deprotection reaction—into a B function.

Step (b) can notably be a Z-functionalization step that can be carried out by:
successive addition of B(OR)₃ and NMe₃O, with R being a C₁-C₄ alkyl; or
by adding a compound (functionalizing agent) that can be chosen notably from the group including iodine; sulfur; oxygen; nitroxyl radicals; carbon dioxide; chlorosilanes such as ClSiR₂H or Cl₂SiRH (R being an alkyl group having from 1 to 20 carbons); isobutene; alkoxysilanes such as SiMe₂(OMe)₂, SiX(OMe)₃, SiXMe(OMe)₂ (X═(CH₂)ₙY, with n=1 to 20 and Y=OMe, NMe₂, S(SiMe₂(CMe₃)), N(SiMe₃)₂); alkyl halides; aryl halides; vinyl halides; and disulfides such as CS₂ or tetraethylthiuram disulfide.

The Z-functionalization step is advantageously carried out by adding iodine, or sulfur, or tetraethylthiuram or O,O-diethyl dithiobis[thioformate] disulphide.

This second stage of the process consists in introducing the group Z by cleavage of the Y-A bonds of the compound of formula (I).

One of the advantages of the process according to the invention is that it is possible to carry out all the steps (a-b or a-c) in situ. This is because, unlike processes of prior art concerning the preparation of monofunctional or telechelic polyolefins, the process described above makes it possible to dispense with the steps of separation/isolation/purification of the intermediate compounds, in that the second step can be implemented in situ. The polymerization and the functionalization can advantageously be carried out successively, with no intermediate purification stage, and notably in the same reactor.

Moreover, the polymerization has a pseudo-live character; this process makes it possible to control the molar mass in order to obtain a relatively-narrow molecular weight distribution—advantageously less than 1.5.

In general, the experimental conditions enable one to control the molar mass of the polyolefin of formula (III) or (IV), as well as its degree of functionalization of the ends by the groups B′ (or B) and Z. The degree of functionalization can be estimated by % F:

% F=100×[number of B′ (or B) ends per chain]×[number of Z ends per chain],

with the maximum number of B′ (or B) ends per chain being a maximum of 1.

The number of B′ (or B) and Z ends are determined by NMR (nuclear magnetic resonance), using techniques known to an appropriately-qualified professional.

The degree of functionalization can thus advantageously be greater than 70% and, even more advantageously, greater than 90%. In other words, the process according to the invention makes it possible to advantageously produce at least 90% of monofunctional or telechelic polyolefins.

Advantageously, step (b) makes it possible to obtain a polyolefin of formula (III) or (IV)

Z-A-(CH₂)ₚ—B′ (III)

Z-A-(CH₂)ₚ—B (IV)

in which:
A is a polymer chain obtained by homopolymerization of ethylene or by copolymerization of ethylene and an alpha-mono-olefin;
B′ is selected from the group consisting of N(SiMe₃)₂; N(SiMe₂CH₂CH₂SiMe₂); para-C₆H₄(NMe₂); para-C₆H₄(OMe); C₆H₄(N(SiMe₃)₂); ortho-CH₂—C₆H₄NMe₂; ortho-CH₂—C₆H₄OMe; C₆F₅; C₃F₇; C₆F₁₃; CH(OCH₂CH₂O);
B is the B′ function or a function derived from B′;
P is an integer from 0 to 50—preferably from 0 to 11;
Z is a function selected from the group consisting of hydrogen; halogens; thiols; thiol derivatives; azides; amines; alcohols; carboxylic acid function; isocyanates; silanes; phosphorus derivatives; dithioesters; dithiocarbamates; dithiocarbonates; trithiocarbonates; alkoxyamines; vinyl function; dienes; and the -A-(CH₂)ₚ—B′ group.

When Z=H, the polyolefin of formula (III) or (IV) is advantageously obtained by cleavage of the Y-A bonds by hydrolysis—preferentially with a protic component such as methanol.

When Z≠H, the polyolefin of formula (III) or (IV) is telechelic. In this case, the groups A, B′, B are such as described above, while Z is a function chosen from the group consisting of halogens; thiols; thiol derivatives; azides; amines; alcohols; carboxylic acid function; isocyanates; silanes; phosphorus derivatives; dithioesters; dithiocarbamates; dithiocarbonates; trithiocarbonates; alkoxyamines; vinyl function; dienes; and the -A-(CH₂)ₚ—B′.

According to one particular implementation, B′ is not one of the ortho-CH₂—C₆H₄NMe₂ and ortho-CH₂—C₆H₄OMe groups.

The invention herein also pertains to derivatives of the telechelic polyolefin (Z≠H) of formula (III) or (IV), namely any polyolefin resulting from the functionalization of at least one of the chain ends of the telechelic polyolefin of formula (III) or (IV). It is therefore a matter of modifying the group B′ and/or the Z group, in accordance with reactions known to an appropriately-skilled professional.

The modification of the group B′ into group B makes it possible to obtain a polyolefin of formula (IV) Z-A-(CH₂)ₚ—B, in which B denotes a function derived from the B′ function. In general, the B function designates either the B′ function or a function derived from B′, namely a function obtained by modification of B, in accordance with the reactions known to an appropriately-skilled professional. The functional group B can in particular be NH₂, NH₃⁺X⁻ (where X=halogen, for example).

According to a particularly-preferred implementation, the Z group in the formulas (III) and (IV) is a halogen—even more advantageously an iodine atom, I—or a dithiocarbamate such as diethyldithiocarbamate (S—C(═S)—N(Et)₂), or a dithiocarbonate such as S—C(═S)—OEt.

The ends of the main polymer chain of the telechelic polyolefin of formula (III) or (IV) can have two groups, in this case B′ (or B) and Z, of which the respective reactivities are very different from one another; the Z is advantageously distinct from the function B′ (or B).

Consequently, and according to a particularly preferred implementation, the telechelic polyolefin is of formula (IV) B—(CH₂)ₚ-A-Z, with Z being preferably an iodine atom or a dithiocarbamate, with p being an integer from 0 to 11, and with B preferably being the group NH₃Cl. Advantageously, the polymer chain A is polyethylene (CH₂—CH₂)ₙ, where n is an integer from 7 to 3600—advantageously from 17 to 360.

According to one particular implementation, the telechelic polyolefin according to the invention is of formula (IV) and is obtained when:
A is polyethylene;
A has an average molar mass of between 500 and 100,000 g/mol;
B=ClH₃N;
P=1 to 11;
Y=Mg;
Z=I;
the preparation of the compound of formula (I) is carried out in the presence of the catalyst involving the compound (C₅Me₅)₂NdCl₂Li(OEt₂)₂.

It can advantageously be obtained via a process consisting in:
preparation of the compound of formula (I) (with A=(CH₂—CH₂)ₙ, B′=(CH₂)ₚ—N(SiMe₂CH₂CH₂SiMe₂); p=3; n=16 to 360) by polymerization of ethylene, CH₂═CH₂, in the presence of (C₅Me₅)₂NdX₂Li(OEt₂)₂, with X being a halogen, and the transfer agent Mg₂)₃—N(SiMe₂CH₂CH₂SiMe₂))₂;
functionalization by Z, by addition of I₂ and modification of the group B′ into group B=ClH₃N so as to obtain the telechelic polyolefin ClH₃N—(CH₂)₃—(CH₂—CH₂)ₙ—I.

The derivatives of the monofunctional or telechelic polyolefin of formula (III) or (IV) can, as already stated, be obtained by the process described above, notably by modifying at least one of the ends of the telechelic polyolefin, preferably the B′ (or B) function, in a step subsequent to the Z-functionalization.

Because of the B′ (or B) and Z groups of the telechelic polyolefin of formula (III) or (IV), the two groups can be easily modified subsequently by organic chemistry, to introduce new groups either via the Z group or via the B′ (or B) group as described, for example, for monofunctional polyethylenes by D'Agosto, Boisson et al. (R. Briquel, J. Mazzolini, T. Le Bris, O. Boyron, F. Boisson, F. Delolme, F. D'Agosto, C. Boisson, R. Spitz Angew. Chem. Int. Eng. Ed., 47, 9311-9313 (2008); J. Mazzolini, R. Briquel, I. Mokthari, O. Boyron, V. Monteil, F. Delolme, D. Gigmes, D. Bertin, F. D'Agosto, C. Macromolecules 43, 7495-7503 (2010); M. Unterlass, E. Espinosa, F. Boisson, F. D'Agosto, C. Boisson, K. Ariga, I. Khalakhan, R. Charvet, JP. Hill Chem. Common. 47, 7057-7059 (2011); Mazzolini, O. Boyron, V. Monteil, D. Gigmes, D. Bertin, F. D'Agosto, C. Boisson Macromolecules 44, 3381-3387 (2011); E. Espinosa, M. Glassner, C. Boisson, C. Barner Kowollik, F. D'Agosto Macromol. Rapid Commun. 32, 1447-1453 (2011) I. German, W. Khelifi, S. Norsic, C. Boisson, F. D'Agosto Angew. Chem. Int. Engl. Ed., 52, 3438-3441(2013)).

Thus, the telechelic polyolefin of formula (III), B′—(CH₂)ₚ-A-Z (or (IV) B—(CH₂)ₚ-A-Z) can be modified subsequently.

The invention herein also relates, therefore, to the derivatives of the telechelic polyolefin of formula (III) or (IV).

Moreover, the invention herein also pertains to the use of polyolefins (III) or (IV) (telechelic or not) and their derivatives, as an additive for modifying organic, inorganic, hybrid or composite materials, or as a reactive synthon for polymerization.

The domains of interest of the invention herein notably include, but are not limited to, additives for polyolefins, organic and inorganic fill modifiers, cosmetics, adhesives, inks, waxes, lubricants and coatings.

The telechelic or non-telechelic polyolefins (Z=H) of the invention, and their derivatives, can be used for the preparation of architectures or of original materials based on polyethylene and polypropylene, in particular.

In contrast to methods of prior art, the invention herein makes it possible to obtain—in a single step—a polyolefin (telechelic or otherwise) incorporating a chain end of ammonium, amine, acetal, aldehyde, fluoroalkyl ether or perfluoroaryl type. It is the nature of the transfer agent—and notably of its group B′—which allows this direct and rapid functionalization. The presence of an ammonium function at the end of the chain is particularly attractive for facilitating its incorporation into more-complex organic or inorganic structures.

The invention and the advantages resulting therefrom will become more apparent from the following examples provided to illustrate the invention, without being limitative.

### EXAMPLES OF IMPLEMENTATION OF THE INVENTION

Polyethylenes of formula (IV) have been prepared from the transfer agent MgR₂ (R=(CH₂)₃—N(SiMe₂CH₂CH₂SiMe₂) or (CH₂)₃—N(SiMe₃)₂) described hereinafter.

Nuclear Magnetic Resonance (NMR)

High-resolution NMR spectroscopy has been performed on a Bruker DRX 400 spectrometer operating at 400 MHz for the proton. The acquisitions were made at 363 K, using a 5 mm QNP probe. The samples were analyzed at a concentration of 5-15% by mass. A mixture of tetrachlorethylene (TCE) and deuterated benzene (C₆D₆) (2/1 v/v) was used as the solvent. The chemical shifts are stated in ppm units, relative to tetramethylsilane as internal reference.

Steric Exclusion Chromatography (SEC)

High-temperature steric exclusion chromatography (HT-SEC) analyses were carried out using a Viscotek appliance (from Malvern Instruments) equipped with 3 columns (PLgel Olexis 300 mm×7 mm I. D. from Agilent Technologies) and 3 detectors (refractometer, viscometer and light scattering). 200 μL of a solution of the sample, at a concentration of 5 mg·mL⁻¹ was eluted in 1,2,4-trichlorobenzene using a flow rate of 1 mL min at 150° C. The mobile phase was stabilized with 2,6-di(tert-butyl)-4-methylphenol (200 mg L⁻¹). OmniSEC software was used for data acquisition and analysis. The molar masses are calculated using a calibration curve obtained from standard polyethylenes (Mₚ: 170, 395, 750, 1,110, 2,155, 25,000, 77,500, 126,000 g·mol⁻¹) from Polymer Standard Service (Mainz).

### Example 1

### Preparation of the Transfer Agent MgR₂ (R=1-propyl-2,2,5,5-tetramethyl-1-aza-2,5-disilacyclopentane=(CH₂)₃—N(SiMe₂CH₂CH₂SiMe₂))

2.6 g (2 equivalents) of magnesium and then 50 ml of dry dibutyl ether is inserted into a 100 mL flask under an argon inert atmosphere.

The flask is placed in a cold bath at 0° C., and 13.3 mL (15 g, 1 equivalent) of 1-(3-bromopropyl)-2,2,5,5-tetramethyl-1 aza-2,5-disilacyclopentane is then added. The solution is allowed to gradually return to ambient temperature, with magnetic stirring.

The solution of 1-(3-bromopropyl)-2,2,5,5-tetramethyl-1-aza-2,5-disilacyclopentane magnesium is then recovered by canulation in a Schlenk under argon to eliminate magnesium, which does not react.

To this solution, 5.5 ml (1.2 equivalents) of dioxane is added to displace the Schlenk equilibrium, to form the compound MgR₂ (R=1-propyl-2,2,5,5-tetramethyl-1-aza-2,5-disilacyclopentane) and precipitate MgBr₂.

This solution is then filtered under argon on celite, to recover MgR₂ in solution in dibutyl ether.

### Example 2

### Preparation of the Transfer Agent MgR₂ (R=1-propyl-2,2,5,5-tetramethyl-1-aza-2,5-disilacyclopentane=(CH₂)₃—N(SiMe₂CH₂CH₂SiMe₂))

2.6 g (2 equivalents) of magnesium and then 50 mL of dry THF is inserted into a 100 mL flask under an argon inert atmosphere.

13.3 ml (15 g, 1 equivalent) of 1-(3-bromopropyl)-2,2,5,5-tetramethyl-1-aza-2,5-disilacyclopentane are then added dropwise at ambient temperature. The solution is left under magnetic stirring for one hour.

The solution of 1-(3-bromopropyl)-2,2,5,5-tetramethyl-1-aza-2,5-disilacyclopentane magnesium is then recovered by canulation in a Schlenk under argon to eliminate magnesium, which does not react.

To this solution, 5.5 ml (1.2 equivalents) of dioxane is added to displace the Schlenk equilibrium, to form the compound MgR₂ (R=1-propyl-2,2,5,5-tetramethyl-1-aza-2,5-disilacyclopentane) and precipitate MgBr₂.

This solution is then filtered under argon on celite, to recover MgR₂ in solution in the THF.

The THF is then distilled under vacuum at ambient temperature and the MgR₂ is then dissolved in dibutyl ether.

¹H NMR (THF-d8—400 MHz—298K) δ: ppm=2.63 (m, —CH₂—N), 1.60 (m, —CH₂—CH₂—N), 0.64 (s, N—Si(CH₃)₂—CH₂—), 0.01 (s, N—Si(CH₃)₂—CH₂—), −0.78 (Mg—CH₂—)

### Example 3

### Preparation of the Polyolefin Z-A-(CH₂)₃—B (with Z=H; A=(CH₂—CH₂)ₙ, and B=NH₃Cl)

21.7 ml (4.77 mmol) of MgR₂ prepared according to example 2 (0.22 M in dibutyl ether) are inserted in a flask containing 400 ml of dry toluene.

The solution is transferred under an argon atmosphere into a 500 mL reactor.

A solution of 20.7 mg of compound (C₅ Me₅)₂ NdCl₂ Li. (OEt₂)₂(32 μmol).

The argon is then removed under vacuum, and the reactor is pressurized to 3 bar of ethylene at 70° C. The pressure is kept constant in the reactor during polymerization, by means of a reservoir.

When the desired amount of ethylene has been consumed, the reactor is degassed and the temperature is brought back to 20° C.

A methanol/HCl solution is added, and the medium is stirred for 1 hour.

The polymer is then filtered, washed with methanol and then dried.

15.3 g of polyethylene CH₃—(CH₂CH₂)ₙ—(CH₂)₃NH₃Cl (82% functionality, Mn=1850 g·mol⁻¹ by NMR) are recovered.

¹H NMR (2/1 v/v TCE/C₆D₆, 400 MHz, 363K) δ ppm=8.29 (broad, —NH₃Cl), 2.87 (t, J=7 Hz, —CH₂—NH₃Cl), 1.73 (quin, J=7 Hz, —CH₂CH₂NH₃Cl) 1.24 (broad, (CH₂CH₂)ₙ), 0.83 (t, J=7 Hz, —CH₂—CH₃).

¹³C NMR (2/1 v/v TCE/C₆D₆, 101 MHz, 363K) δ ppm=39.72, 32.21 30.00 ((CH₂CH₂)ₙ), 29.61, 29.25, 27.80, 26.85, 22.90, 14.04.

### Example 4

### Preparation of Polyolefin ZA-(CH₂)₃—B (with Z=H; A=(CH₂—CH₂)ₙ and B=NH₂)

21.7 mL (4.77 mmol) of MgR₂ prepared according to example 2 (0.22 M in dibutyl ether) is inserted into a flask containing 400 mL of dry toluene.

The solution is transferred under an argon atmosphere into a 500 mL reactor.

A solution of 21.4 mg of compound (C₅Me₅)₂ NdCl₂Li.(OEt₂)₂(33 μmol).

The argon is then removed under vacuum, and the reactor is pressurized to 3 bar of ethylene at 70° C. The pressure is kept constant in the reactor during polymerization, by means of a reservoir.

When the desired amount of ethylene has been consumed, the reactor is degassed and the temperature is brought back to 20° C.

A methanol/HCl solution is added, and the medium is stirred for 1 hour.

The resulting suspension is poured into IM methanol/NaOH solution and stirred for 1 hour.

The polymer is then filtered, washed with methanol and then dried.

15.0 g of polyethylene CH₃—(CH₂CH₂)ₙ—(CH₂)₃NH₂ (functionality 80%, Mn=1820 g·mol⁻¹ by NMR) are recovered.

¹H NMR (2/1 v/v TCE/C₆D₆, 400 MHz, 363K) δ ppm=2.53 (broad, CH₂—NH₂), 1.24 (broad, (CH₂CH₂)ₙ), 0.83 (t, J=7 Hz, —CH₂—CH₃).

¹³C NMR (2/1 v/v TCE/C₆D₆, 101 MHz, 363K) δ ppm=42.55, 34.44, 32.21, 30.00 ((CH₂CH₂)), 29.61, 27.25, 22.90, 14.04.

### Example 5

### Preparation of the Telechelic Polyolefin ZA-(CH₂)₃—B (with Z=I; A=(CH₂—CH₂)ₙ and B=NH₃C)

8.4 ml of MgR₂ prepared according to example 2 (in solution in 0.3 M of dibutyl ether) are inserted into a flask containing 400 ml of dry toluene.

The solution is transferred under an argon atmosphere into a 500 mL reactor.

A solution of 10.7 mg of compound (C₅Me₅)₂ NdCl₂Li (OEt₂)₂ (molar ratio Mg/Nd=150) is then transferred.

The argon is then removed under vacuum, and the reactor is pressurized to 3 bar of ethylene at 70° C. The pressure is kept constant in the reactor during polymerization, by means of a reservoir.

When the desired amount of ethylene has been consumed, the reactor is degassed and the temperature is brought back to 20° C.

A solution of 2.5 g of iodine in THF (molar ratio I/Mg=4) is added, and the medium is stirred for 2 hours.

A methanol/HCl solution is added, and the medium is stirred for 1 hour.

The resulting suspension is poured into methanol and then the polymer is filtered, washed with methanol and then dried.

4.5 g of telechelic polyethylene I—(CH₂CH₂)ₙ—(CH₂)₃ NH₃Cl (100% functionality, Mn=1350 g·mol⁻¹ by NMR) are recovered.

¹H NMR (2/1 v/v TCE/C₆D₆, 400 MHz, 363K) δ ppm=8.29 (broad, —NH₃Cl), 2.94 (t, J=7 Hz, —CH₂I), 2.87 (t, J=7 Hz, —CH₂—NH₃Cl), 1.73 (quin, J=7 Hz, —CH₂CH₂NH₃Cl), 1.66 (quin, J=7 Hz, —CH₂CH₂I), 1.24 (broad, (CH₂CH₂)ₙ).

¹³C NMR (2/1 v/v TCE/C₆D₆, 101 MHz, 363K) δ ppm=39.72, 30.77, 30.00 ((CH₂CH₂)ₙ), 29.68, 29.25, 28.81, 27.80, 26.85, 4.91.

### Example 6

### Preparation of the Transfer Agent MgR₂ (R=N, N-bis (trimethylsilyl) propan-1-amine=(CH₂)₃—N(SiMe₃)

2.6 g (2 equivalents) of magnesium and then 50 mL of dry THF is inserted into a 100 mL flask under an argon inert atmosphere.

15 g (1 equivalent) of 3-bromo-N, N-bis (trimethylsilyl) propan-1-amine are then added dropwise, at room temperature. The solution is left under magnetic stirring for one hour.

The solution of 3-bromo-N, N-bis (trimethylsilyl) propan-1-amine magnesium is then recovered by canulating in a Schlenk under argon, to remove the unreacted magnesium.

To this solution, 5.5 ml (1.2 equivalents) of dioxane is added to displace the Schlenk equilibrium, to form the compound MgR₂ (R=N, N-bis (trimethylsilyl) propan-1-amine) and Precipitate MgBr₂.

This solution is then filtered under argon on celite, to recover MgR₂ in solution in the THF.

The THF is then distilled under vacuum at ambient temperature, and the MgR₂ is then dissolved in dibutyl ether to obtain a 0.40 M solution.

### Example 7

### Preparation of the Polyolefin Z-A-(CH₂)₃—B (with Z=H; A=(CH₂—CH₂)ₙ, and B=NH₃Cl)

6.3 ml (2.52 mmol) of MgR₂ prepared according to example 6 (0.40 M in dibutyl ether) are inserted in a flask containing 400 ml of dry toluene.

The solution is transferred under an argon atmosphere into a 500 mL reactor.

A solution of 10.7 mg of compound (C₅Me₅)₂ NdCl₂Li.(OEt₂)₂(16 μmol).

The argon is then removed under vacuum, and the reactor is pressurized to 3 bar of ethylene at 70° C. The pressure is kept constant in the reactor during polymerization, by means of a reservoir.

When the desired amount of ethylene has been consumed, the reactor is degassed and the temperature is brought back to 20° C.

A methanol/HCl solution is added, and the medium is stirred for 1 hour.

The polymer is then filtered, washed with methanol and then dried.

5.3 g of polyethylene CH₃—(CH₂CH₂)ₙ—(CH₂)₃NH₃Cl (84% functionality, Mn=1440 g·mol⁻¹ by NMR) are recovered.

1H NMR (2/1 v/v TCE/C₆D₆, 400 MHz, 363K) δ ppm=8.62 (broad, —NH₃Cl), 2.86 (—CH₂—NH₃Cl), 1.75 (quin, J=7 Hz, —CH₂CH₂NH₃Cl) 1.29 (broad, (CH₂CH₂)ₙ), 0.86 (t, J=7 Hz, —CH₂—CH₃).

### Example 8

### Preparation of Polyolefin Z-A-(CH₂)₃—B (with Z=H; A=(CH₂—CH₂) and B=NH₂)

6.3 ml (2.52 mmol) of MgR₂ prepared according to example 6 (0.40 M in dibutyl ether) are inserted in a flask containing 400 ml of dry toluene.

The solution is transferred under an argon atmosphere into a 500 mL reactor.

A solution of 10.7 mg of compound (C₅Me₅)₂ NdCl₂Li.(OEt₂)₂(16 μmol).

The argon is then removed under vacuum, and the reactor is pressurized to 3 bar of ethylene at 70° C. The pressure is kept constant in the reactor during polymerization, by means of a reservoir.

When the desired amount of ethylene has been consumed, the reactor is degassed and the temperature is brought back to 20° C.

A methanol/HCl solution is added, and the medium is stirred for 1 hour.

The resulting suspension is poured into IM methanol/NaOH solution and stirred for 1 hour.

The polymer is then filtered, washed with methanol and then dried.

5.0 g of polyethylene CH₃—(CH₂CH₂)ₙ—(CH₂)₃NH₂ (functionality 84%, Mn=1440 g·mol⁻¹ by NMR) are recovered.

¹H NMR (2/1 v/v TCE/C₆D₆, 400 MHz, 363K) δ ppm=2.53 (broad, CH₂—NH₂), 1.24 (broad, (CH₂CH₂)ₙ), 0.83 (t, J=7 Hz, —CH₂—CH₃).

### Example 9

### Preparation of Polyolefin ZA-(CH₂)₃—B (with Z=OH; A=(CH₂—CH₂)ₙ and B=NH₃Cl)

6.3 ml (2.52 mmol) of MgR₂ prepared according to example 6 (0.40 M in dibutyl ether) are inserted a flask containing 400 ml of dry toluene.

The solution is transferred under an argon atmosphere into a 500 mL reactor.

A solution of 10.7 mg of compound (C₅Me₅)₂ NdCl₂Li.(OEt₂)₂(16 μmol).

The argon is then removed under vacuum, and the reactor is pressurized to 3 bar of ethylene at 70° C. The pressure is kept constant in the reactor during polymerization, by means of a reservoir.

When the desired amount of ethylene has consumed, the reactor is degassed and a solution of triethyl borate B(OEt)₃ (2.55 mL in 10 mL of toluene B/Mg=6) is added under argon. The medium is stirred for 2 hours, and then a solution of trimethylamine N oxide TAO (2.5 g in 20 mL of DMF TAO/B=1.5) is added under argon.

The medium is stirred for 2 hours, and then the temperature is brought to 20° C.

A methanol/HCl solution is added, and the medium is stirred for 1 hour.

The polymer is then filtered, washed with methanol and then dried.

6.3 g of polyethylene HO—CH₂—(CH₂CH₂)ₙ—(CH₂)₃NH₃Cl (70% functionality, Mn=1940 g·mol⁻¹ by NMR) are recovered.

¹H NMR (2/1 v/v TCE/C₆D₆, 400 MHz, 363K) δ ppm=8.63 (broad, —NH₃Cl), 3.40 (t, J=7 Hz, HO—CH₂—) 2.86 (broad, —CH₂—NH₃Cl), 1.75 (quin, J=7 Hz, —CH₂CH₂NH₃Cl) 1.29 (broad, (CH₂CH₂)ₙ).

### Example 10

### Preparation of the Polyolefin Z-A-(CH₂)₃—B (with Z=S—(C═S)—N(CH₂—CH₃)₂; A=(CH₂—CH₂)ₙ, and B=NH₃Cl)

6.3 ml (2.52 mmol) of MgR₂ prepared according to example 6 (0.40 M in dibutyl ether) are inserted a flask containing 400 ml of dry toluene.

The solution is transferred under an argon atmosphere into a 500 mL reactor.

A solution of 10.7 mg of compound (C₅Me₅)₂ NdCl₂Li.(OEt₂)₂(16 μmol).

The argon is then removed under vacuum, and the reactor is pressurized to 3 bar of ethylene at 70° C. The pressure is kept constant in the reactor during polymerization, by means of a reservoir.

When the desired amount of ethylene has been consumed, the reactor is degassed and a solution of tetraethylthiuram disulfide (1.5 g, 2 equivalents in 20 mL of toluene) is added under argon.

The medium is stirred for 2 hours, and then the temperature is brought to 20° C.

A methanol/HCl solution is added, and the medium is stirred for 1 hour.

The polymer is then filtered, washed with methanol and then dried.

5.6 g of polyethylene (CH₃—CH₂)₂N—(CH₂CH₃)ₙ—(CH₂)₃NH₃Cl (functionality 100%; Mn=1480 g·mol⁻¹ by NMR).

¹H NMR (2/1 v/v TCE/C₆D₆, 400 MHz, 363K) δ ppm=8.59 (broad, —NH₃Cl), 3.64 (q, J=7 Hz (CH₃—CH₂)₂N—(S═C)—S), 3.30 (t, J=7 Hz, (CH₃—CH₂)₂N—(S═C)—S—CH₂—) 2.88 (broad, —CH₂—NH₃Cl), 1.77 (broad, —CH₂CH₂NH₃Cl), 1.67 (quin, J=7 Hz, (CH₃—CH₂)₂N—(S═C)—S—CH₂—CH₂—), 1.29 (broad, (CH₂CH₂)ₙ), 1.04 (t, J=7 Hz (CH₃—CH₂)₂N—(S═C)—S).

### Example 11

### Preparation of the telechelic Polyolefin ZA-(CH₂)₃—B (with Z=I; A=(CH₂—CH₂)ₙ and B=NH₃Cl)

6.3 ml (2.52 mmol) of MgR₂ prepared according to example 6 (0.40 M in dibutyl ether) are inserted a flask containing 400 ml of dry toluene.

The solution is transferred under an argon atmosphere into a 500 mL reactor.

A solution of 10.7 mg of compound (C₅ Me₅)₂ NdCl₂ Li. (OEt₂)₂(16 μmol).

The argon is then removed under vacuum, and the reactor is pressurized to 3 bar of ethylene at 70° C. The pressure is kept constant in the reactor during polymerization, by means of a reservoir.

When the desired amount of ethylene has been consumed, the reactor is degassed and the temperature is brought back to 20° C.

A solution of 2.5 g of iodine in THF (molar ratio I/Mg=4) is added, and the medium is stirred for 2 hours.

A methanol/HCl solution is added, and the medium is stirred for 1 hour.

The resulting suspension is poured into methanol and then the polymer is filtered, washed with methanol and then dried.

6.3 g of telechelic polyethylene I—(CH₂CH₂)ₙ—(CH₂)₃ NH₃Cl (100% functionality, Mn=1300 g·mol⁻¹ by NMR) are recovered.

¹H NMR (2/1 v/v TCE/C₆D₆, 400 MHz, 363K) δ ppm=8.30 (broad, —NH₃Cl), 2.91 (t, J=7 Hz, —CH₂I), 2.86 (t, J=7 Hz, —CH₂—NH₃Cl), 1.73 (quin, J=7 Hz, —CH₂CH₂NH₃Cl), 1.63 (quin, J=7 Hz, —CH₂CH₂I), 1.26 (broad, (CH₂CH₂)ₙ).

1. A method for preparing a polyolefin having at least one functionalized chain end, the method comprising the following step (a):
(a) preparation of a compound of formula (I) by homopolymerization of ethylene, or by copolymerization of ethylene and an alpha-monoolefin in the presence of a transfer agent of formula (II):
Y(A-(CH₂)ₚ—B′)ₘ (I)
Y((CH₂)ₚB′)ₘ (II)
wherein:
when m is 2, Y is an alkaline earth metal or zinc, and when m is 3, Y is aluminum;
A is a polymer chain obtained by homopolymerization of ethylene, or by copolymerization of ethylene and an alpha-mono-olefin;
B′ is selected from the group consisting of N(SiMe₃)₂, N(SiMe₂CH₂CH₂SiMe₂), para-C₆H₄(NMe₂), para-C₆H₄(OMe), C₆H₄(N(SiMe₃)₂), ortho-CH₂—C₆H₄NMe₂, ortho-CH₂—C₆H₄OMe, C₆F₅, C₃F₇, C₆F₁₃, and CH(OCH₂CH₂O); and
p is an integer from 0 to 50.

2. The method according to claim 1, wherein A is a polymer of 70 to 100 mol % of ethylene and 0 to 30 mol % of an alpha-monoolefin selected from the group consisting of styrene, styrene derivatives, and olefins of the formula: CH₂═CH—CₓH₂ₓ₊₁, wherein x is an integer from 1 to 6.

3. The method according to claim 1, wherein the transfer agent is Mg [(CH₂)ₚ—N(SiMe₂CH₂CH₂SiMe₂)]₂ or Mg [(CH₂)ₚ—N(SiMe₃)₂]₂; wherein p is an integer from 1 to 11.

4. The method according to claim 1, wherein the preparation of the compound of formula (I) is carried out in the presence of a catalyst based on a transition metal or a lanthanide.

5. The method according to claim 4, wherein the catalyst is of the formula: (Cp¹)(Cp²)M or E(Cp¹)(Cp²)M, wherein:
M is a group 3 or 4 metal or a lanthanide;
Cp¹ is a cyclopentadienyl, fluorenyl, or substituted or unsubstituted indenyl group;
Cp² is a cyclopentadienyl, fluorenyl, or substituted or unsubstituted indenyl group; and
the group E is a group bridging the two groups Cp¹ and Cp².

6. The method according to claim 4, wherein the catalyst is obtained from the compound (C₅Me₅)₂NdCl₂Li(OEt₂)₂ or a metallocene borohydride compound of a lanthanide.

7. The method according to claim 1, wherein step (a) is followed by a step (b) that includes reacting the compound of formula (I) with a chain terminating agent.

8. The method according to claim 7, wherein step (b) is a Z-functionalization step that is performed:
by successive addition of B(OR)₃ and NMe₃O, wherein R is a C₁-C₄ alkyl; or
by adding a compound selected from the group consisting of iodine, sulfur, oxygen, nitroxyl radicals, carbon dioxide, the chlorosilanes, isobutene, alkoxysilanes, alkyl halides, aryl halides, vinyl halides, and disulfides.

9. The method according to claim 8, wherein the polyolefin is of formula (III) or (IV):
Z-A-(CH₂)ₚ—B′ (III)
Z-A-(CH₂)ₚ—B (IV),
wherein:
Z is a group selected from the group consisting of hydrogen halogens, thiols, thiol derivatives, azides, amines, alcohols, carboxylic acids, isocyanates, silanes, phosphorus derivatives, dithioesters, dithiocarbamates, dithiocarbonates, trithiocarbonates, alkoxyamines, vinyl groups, dienes; and the group -A-(CH₂)ₚ—B′, wherein
B is the group B′, or a group derived from B′.

10. A telechelic polyolefin of formula (III) or (IV):
Z-A-(CH₂)ₚ—B′ (III)
Z-A-(CH₂)ₚ—B (IV),
wherein:
A is a polymer chain obtained by homopolymerization of ethylene or by copolymerization of ethylene and an alpha-mono-olefin;
B′ is selected from the group consisting of N(SiMe₃)₂, N(SiMe₂CH₂CH₂SiMe₂), para-C₆H₄(NMe₂), para-C₆H₄(OMe), C₆H₄(N(SiMe₃)₂), ortho-CH₂—C₆H₄NMe₂, ortho-CH₂—C₆H₄OMe, C₆F₅, C₃F₇, C₆F₁₃, and CH(OCH₂CH₂O);
B is the group B′, or a group derived from B′;
P is an integer from 0 to 50; and
Z is selected from the group consisting of halogens, thiols, thiol derivatives, azides, amines, alcohols, carboxylic acids, isocyanates, silanes, phosphorus derivatives, dithioesters, dithiocarbamates, dithiocarbonates, trithiocarbonates, alkoxyamines, vinyl groups, dienes; and the group -A-(CH₂)ₚ—B′.

11. The telechelic polyolefin of claim 10, wherein the polyolefin is of formula (IV);
B is NH₃Cl;
A a polyethylene chain with an average molar mass of between 500 and 100,000 g/mol;
p is greater than or equal to 1 and less than or equal to 11;
Y is Mg; and
Z is I.

12. The method according to claim 1, wherein p is an integer from 0 to 11.

13. The method according to claim 6, wherein the catalyst is obtained from a compound selected from the group consisting of {(Me₂Si(C₁₃H₈)₂)Nd(μ-BH₄)[(μ-BH₄)Li(THF)]}₂, Me₂Si(C₁₃H₈)₂)Nd(BH₄)(THF), (Me₂Si(2,7-tBu₂-C₁₃H₆)₂)Nd(BH₄)(μ-BH₄)Li(ether)₃, Me₂Si(3-Me₃Si—C₅H₃)₂NdBH₄(THF)₂, {Me₂Si(3-Me₃Si—C₅H₃)₂NdCl}, {Me₂Si(C₅H₄)(C₁₃H₈)NdCl}, and [Me₂Si(C₅H₄)(C₁₃H₈)Nd(BH₄)₂][Li(THF)].

14. The telechelic polyolefin of claim 10, wherein p is an integer from 0 to 11.

15. The method according to claim 2, wherein the transfer agent is Mg [(CH₂)ₚ—N(SiMe₂CH₂CH₂SiMe₂)]₂ or Mg [(CH₂)ₚ—N(SiMe₃)₂]₂; wherein p is an integer from 1 to 11.

16. The method according to claim 2, wherein the preparation of the compound of formula (I) is carried out in the presence of a catalyst based on a transition metal or a lanthanide.

17. The method according to claim 16, wherein the catalyst is obtained from the compound (C₅Me₅)₂NdCl₂Li(OEt₂)₂ or a metallocene borohydride compound of a lanthanide.

18. The method according to claim 17, wherein the catalyst is obtained from a compound selected from the group consisting of {(Me₂Si(C₁₃H₈)₂)Nd(μ-BH₄)[(μ-BH₄)Li(THF)]}₂, Me₂Si(C₁₃H₈)₂)Nd(BH₄)(THF), (Me₂Si(2,7-tBu₂-C₁₃H₆)₂)Nd(BH₄)(μ-BH₄)Li(ether)₃, Me₂Si(3-Me₃Si—C₅H₃)₂NdBH₄(THF)₂, {Me₂Si(3-Me₃Si—C₅H₃)₂NdCl}, {Me₂Si(C₅H₄)(C₁₃H₈)NdCl}, and [Me₂Si(C₅H₄)(C₁₃H₈)Nd(BH₄)₂][Li(THF)].

19. The method according to claim 2, wherein step (a) is followed by a step (b) that includes reacting the compound of formula (I) with a chain terminating agent.

20. The method according to claim 19, wherein step (b) is a Z-functionalization step that is performed:
by successive addition of B(OR)₃ and NMe₃O, wherein R is a C₁-C₄ alkyl; or
by adding a compound selected from the group consisting of iodine, sulfur, oxygen, nitroxyl radicals, carbon dioxide, the chlorosilanes, isobutene, alkoxysilanes, alkyl halides, aryl halides. vinyl halides, and disulfides.
